(19) United States
(12) Patent Application Publication
(10) Pub. No.: US 2002/0098067 A1
(43) Pub. Date: Jul. 25, 2002

(54) Slide transfer system for semiconductor wafers

(75) Inventors: Roger De Luna JR., San Antonio, TX (US); Roberto Enrique Bolanos, San Antonio, TX (US); Roland Garcia, Seguin, TX (US)

Correspondence Address: RADER FISHMAN & GRAUER PLLC, LION BUILDING, 1233 20TH STREET N.W., SUITE 501, WASHINGTON, DC, 20036, US

(73) Assignee: Sony Corporation and Sony Electronics, Inc.

(21) Appl. No.: 09/766,585

(22) Filed: Jan. 23, 2001

(51) Int. Cl. B65G 65/00; B65G 65/02

(52) U.S. Cl. 414/404; 414/416.03

(57) ABSTRACT

A slide transfer system is provided for transferring semiconductor wafers from a first carrier cassette to a second process cassette. The system includes a base, a transfer mechanism, and a locking mechanism. The base has a first surface for supporting the first cassette, and a second surface for supporting the second cassette adjacent to the first cassette. The transfer mechanism has a wafer engaging member supported by a slidable support member for reciprocating movement of the wafer engaging member across the first surface of the base. The locking mechanism has an actuator element positioned for engagement by the second cassette placed on the second surface, and a locking element. The locking element has a first position in which sliding movement of the transfer mechanism is prevented, and a second position in which sliding movement of the transfer mechanism is permitted. The actuator element is operable to move the locking element between the first and second positions. With this construction, the locking mechanism allows sliding movement of the transfer mechanism only when a second cassette is placed on the second surface, thereby preventing wafer transfer until the second cassette is in place for receiving the transferred wafers.

### BACKGROUND OF THE INVENTION

1. Field of the Invention

The present invention relates generally to article handling systems. In particular, the present invention relates to a system for handling semiconductor wafers used in the production of integrated circuit components.

2. Description of the Related Art

In the fabrication of semiconductor wafers into integrated circuit chips, the wafers are typically processed through a series of steps in which the wafers are transferred repeatedly from one carrier apparatus to another. For example, a plurality of wafers are usually disposed in a stacked, spaced apart relationship within a sealed carrier. The wafers are supported by a plurality of shelves of a cassette which is itself retainable in the carrier. The cassette is removable from the carrier for transferring the wafers from the carrier to the processing equipment.

Typical semiconductor processes use a number of different types of cassettes to complete the wafer processing and handling. For example, the wafers may be delivered to the fabrication line in a carrier cassette, and then transferred to a suitable process cassette for various processing steps. The process cassettes are designed to withstand extreme temperature and/or chemical conditions that the wafers are subjected to. For example, the process cassettes and the wafers within the process cassettes may be exposed to temperatures of 180° C. or more during treatment of the wafers, and then cooled rapidly to ambient temperatures. At other points in the fabrication line, the process cassettes and the wafers within the process cassettes may be immersed in a chemical bath or the like. Following the respective treatments, the wafers are transferred from the process cassette back to the carrier cassette for storage or transfer to the next processing step.

In a typical fabrication line, slide transfer systems are used to transfer the wafers between the carrier cassette and the various process cassettes. Conventional slide transfer systems have a platform on which the carrier cassette and the process cassette are placed, and a transfer mechanism that pushes the wafers out of the carrier cassette and into the process cassette, and vice versa. However, conventional slide transfer systems allow wafers to be transferred out of the carrier cassette even when a receiving cassette is not in place, thus resulting in damaged wafers.

Thus, there is a need for an improved slide transfer system that will not allow wafers to be transferred out of the carrier cassette unless a receiving cassette is in place.

### SUMMARY OF THE INVENTION

It is an object of the present invention to provide a slide transfer system for semiconductor wafers having a locking mechanism that prevents transfer of the wafers unless a receiving cassette is properly positioned to receive the wafers.

It is a further object of the present invention to provide a slide transfer system that is simple to manufacture, reliable and efficient in use, and that is suitable for use with a wide variety of wafer cassettes.

It is a further object of the present invention to provide a slide transfer system for transferring articles from a first support member to a second support member, and for preventing movement of the articles out of the first support member until the second support member is properly positioned for receiving the same.

According to the present invention, a slide transfer system is provided for transferring semiconductor wafers from a first carrier cassette to a second process cassette. The system includes a base, a transfer mechanism, and a locking mechanism. The base has a first surface for supporting the first cassette and a second surface for supporting the second cassette adjacent to the first cassette. The transfer mechanism has a wafer engaging member supported by a slidable support member, which provides a reciprocating movement of the wafer engaging member across the first surface of the base. The locking mechanism has an actuator element positioned for engagement by the second cassette placed on the second surface, and a locking element. The locking element has a first position in which sliding movement of the transfer mechanism is prevented, and a second position in which sliding movement of the transfer mechanism is permitted. The actuator element is operable to move the locking element between the first and second positions. With this construction, the locking mechanism allows sliding movement of the transfer mechanism only when a second cassette is placed on the second surface in engagement with the actuator member, thereby preventing wafer transfer until the second cassette is in place for receiving the transferred wafers.

According to another broad aspect of the present invention, a slide transfer system is provided for transferring articles from a first support member to a second support member. The slide transfer system comprises: a base having a first surface for supporting a first support member and a second surface for supporting a second support member; a transfer mechanism having an engaging portion arranged for reciprocating movement across the first surface and a supporting portion slidably mounted to the base; and a locking mechanism having a first position in which sliding movement of the transfer mechanism is prevented and a second position in which sliding movement of the transfer mechanism is permitted, the locking mechanism being movable into the second position only when a second support member is placed on the second surface.

Numerous other objects of the present invention will be apparent to those skilled in this art from the following description wherein there is shown and described a preferred embodiment of the present invention, simply by way of illustration of one of the modes best suited to carry out the invention. As will be realized, the invention is capable of other different embodiments, and its several details are capable of modification in various obvious aspects without departing from the invention. Accordingly, the drawings and description should be regarded as illustrative in nature and not restrictive.

### BRIEF DESCRIPTION OF THE DRAWINGS

The present invention will become more clearly appreciated as the disclosure of the invention is made with reference to the accompanying drawings. In the drawings:

FIG. 1 is a side view of a slide transfer system according to the present invention, having a carrier cassette and a process cassette positioned thereon.

FIG. 2 is a top sectional view of a cassette used with the slide transfer system of the present invention.

FIG. 3 is a bottom view of the slide transfer system according to the present invention.

FIG. 4 is a top view of a platform portion of the slide transfer system of the present invention.

FIG. 5 is a bottom view of the platform portion of the slide transfer system of the present invention.

FIG. 6 is a side view of a slide locking mechanism of the slide transfer system of the present invention in a locked position.

FIG. 7 is a side view of the slide locking mechanism in an unlocked position.

FIG. 8 is a plan view of a rocker arm of the slide locking mechanism.

FIG. 9 is a side view of an actuator pin of the slide locking mechanism.

### DETAILED DESCRIPTION OF THE PREFERRED EMBODIMENT

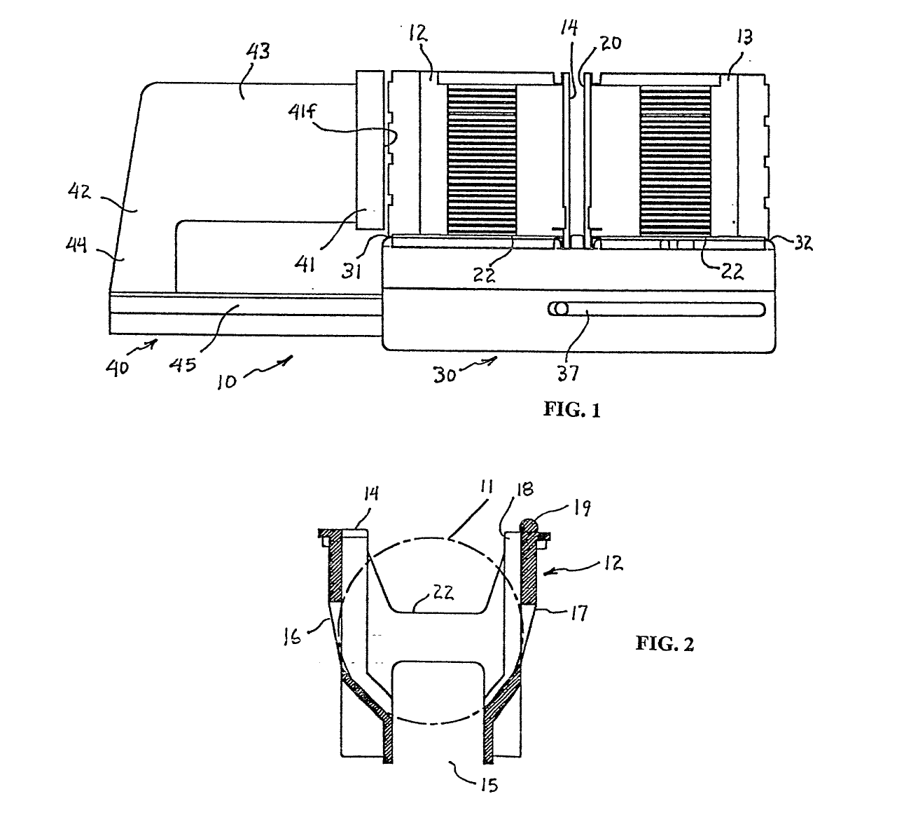

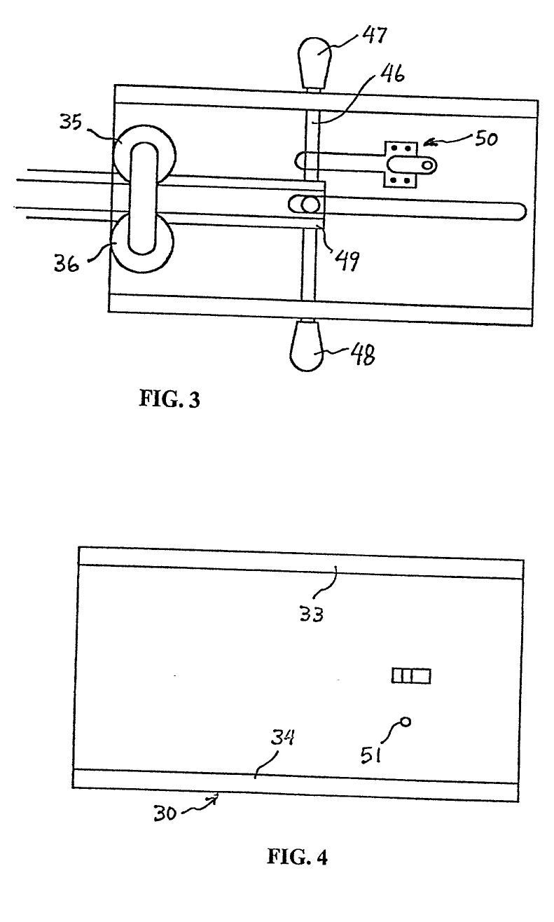

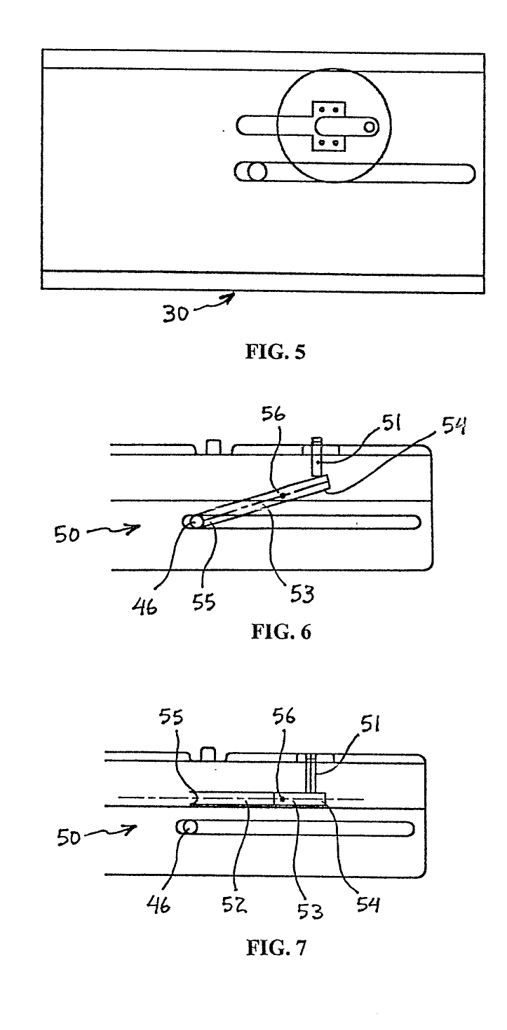

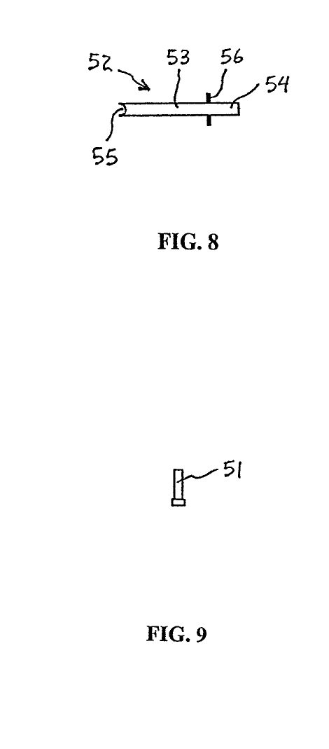

A slide transfer system 10 according to a preferred embodiment of the present invention will be described below with reference to FIGS. 1 to 9 of the accompanying drawings.

The slide transfer system 10 of the present invention is used to transfer semiconductor wafers 11 from a first carrier cassette 12 to a second process cassette 13. The carrier cassette 12 is typically used to transfer and store the wafers 11 between processing steps, and the process cassette 13 is used to hold the wafers 11 while the wafers 11 are subjected to extreme temperatures, chemical baths, and the like during processing. Once the wafers 11 are processed, the slide transfer system 10 can be used to transfer the wafers 11 from the process cassette 13 back into the carrier cassette 12.

Carrier cassettes and process cassettes are known in the art which have a variety of designs and constructions. A plan view of a typical carrier cassette 12 in cross section is shown in FIG. 2. The cassette 12 has an open front side 14, an open rear side 15, and first and second side walls 16 and 17. A plurality of shelves 18 extend from each of the side walls 16, 17 to support a plurality of wafers 11 in a vertical stack within the cassette 12. For example, the cassettes 12 may have a sufficient number of shelves 18 to support a stack of 25 wafers. The process cassette 13 has a similar arrangement of shelves 18 for receiving the stack of wafers 11 transferred from the carrier cassette 12.

An alignment projection 19 is provided on the front side 14 of the carrier cassette 12. A corresponding alignment recess (not shown) is provided on a front side 20 of the process cassette 13 to facilitate alignment of the carrier cassette 12 and the process cassette 13. Other suitable structures may be provided on the bottom side of the cassettes 12, 13 to facilitate alignment of the cassettes relative to the slide transfer system 10.

The open front and rear sides 14 and 15 of the carrier cassette 12 allow a wafer engaging member 41 to pass through the cassette 12 to push the wafers 11 out of the carrier cassette 12 and into the process cassette 13. Thus, the entire vertical stack of wafers 11 can be transferred from the carrier cassette 12 into the process cassette 13 by a single pass of the wafer engaging member 41 through the carrier cassette 12. The process cassette 13 is similarly constructed so that the stack of wafers 11 can be transferred back into the carrier cassette 12 after the processing is completed.

The slide transfer system 10 includes a base 30, a transfer mechanism 40, and a locking mechanism 50. The base 30 has a first surface 31 for supporting the carrier cassette 12 and a second surface 32 for supporting the process cassette 13 adjacent to the carrier cassette 12. The first and second surfaces 31 and 32 may be planar across the width of the base 30, or they may comprise raised side edges 33 and 34 that engage and support the carrier cassette 12 and process cassette 13 only at the respective sides 16 and 17 of the cassettes. The carrier cassette 12 and process cassette 13 each have a bottom surface 22 that engages and rests on the respective first and second surfaces 31 and 32 of the base 30.

The transfer mechanism 40 has a wafer engaging member 41 supported by a slidable support member 42. The wafer engaging member 41 has a front face 41f dimensioned to pass through the open rear side 15 of the carrier cassette 12 to engage and push the stack of wafers 11 out of the carrier cassette 12. The slidable support member 42 has an arm portion 43 connected to the wafer engaging member 41 and extending rearwardly therefrom, an elbow member 44 extending downwardly from the arm portion 43, and a slide mounting portion 45 extending horizontally from the elbow member 44 into the base 30. A pair of guide rollers 35, 36 are provided on the base 30 to guide the slide mounting portion 45 for reciprocating movement into and out of the base 30.

The transfer mechanism 40 further comprises a handle member 46 extending across a width of the base 30. The handle member 46 has a pair of hand grips 47, 48 protruding from respective sides of the base 30 which can be gripped and moved by a human operator. The handle member 46 is movable within a slotted opening 37 of the base 30 by pulling the hand grips 47, 48 forwardly from the position shown in the drawings. The handle member 46 is connected to a front end 49 of the slide mounting portion 45 of the support member 42. Thus, the wafer engaging member 41 is moved across the first surface 31 of the base 30 and into engagement with the stack of wafers 11 upon sliding the handle member 46 forwardly.

The locking mechanism 50 has an actuator pin 51 positioned for engagement by the process cassette 13 when the process cassette 13 is placed correctly on the second surface 32 of the base 30. The actuator pin 51 protrudes upwardly from the second surface 32 of the base 30 when a process cassette 13 is not present on the second surface 32. The actuator pin 51 is engaged and moved downwardly by the bottom surface 22 of the process cassette 13 when the process cassette 13 is placed on the second surface 32.

The locking mechanism 50 further comprises a locking element 52. The locking element 52 comprises a lever 53 having a first end 54 engaged by the actuator pin 51, a second end 55 movable into and out of engagement with the handle member 46 of the transfer mechanism 40, and a pivot pin or fulcrum point 56 located between the first and second ends 54 and 55. The fulcrum point 56 is located closer to the first end 54 of the lever 53 than to the second end 55 of the lever 53. As a result, the center of gravity of the lever 53 is located between the fulcrum point 56 and the second end 55 of the lever 53 such that the lever 53 will return to the position shown in FIG. 6 by gravitational force when the actuator pin 51 is not engaged by a cassette 13 positioned on the second surface 32 of the base 30. A spring or other suitable means can also be provided to bias the lever 53 into the position shown in FIG. 6. In the position shown in FIG. 6, the locking element 52 engages and prevents movement of the handle member 46.

The locking element 52 has a first position (FIG. 6) in which sliding movement of the transfer mechanism 40 is prevented, and a second position (FIG. 7) in which sliding movement of the transfer mechanism 40 is permitted. The actuator pin 51 is operable to move the locking element 52 between the first and second positions. As shown in FIGS. 6 and 7, the actuator pin 51 protrudes upwardly from the second surface 32 of the base 30 when the locking element 52 is in its first position, and the actuator pin 51 is moved downwardly to a generally flush position relative to the second surface 32 of the base 30 when the locking element 52 is in its second position.

The locking mechanism 50 allows sliding movement of the transfer mechanism 40 only when a receiving cassette is placed on the second surface 32 causing the actuator pin 51 to be moved downwardly, thereby preventing wafer transfer until the receiving cassette is in place for receiving the transferred wafers 11. In the case of a transfer of wafers 11 from a carrier cassette 12 to a process cassette 13, the process cassette 13 is the receiving cassette which engages the actuator pin 51. However, in the case of a transfer from a process cassette 13 back to a carrier cassette 12, the carrier cassette 12 then becomes the receiving cassette which engages the actuator pin 51.

In operation, a carrier cassette 12 carrying a plurality of wafers 11 to be processed is placed on the first surface 31 of the slide transfer system 10. If a process cassette 13 is not present on the second surface 32 of the slide transfer system 10, the locking element 52 of the locking mechanism 50 is positioned as shown in FIG. 6 with the second end 55 of the lever 53 engaging the handle member 46 and preventing sliding movement thereof. Thus, the slide transfer system 10 cannot be operated to push the wafers 11 out of the carrier cassette 12 when a process cassette 13 is not present on the second surface 32.

When a process cassette 13 or other receiving cassette is placed on the second surface 32, a lower surface 22 of the cassette engages and moves the actuator pin 51 downwardly. The actuator pin 51 engages the first end of the lever 53 and causes the lever 53 to pivot around the fulcrum point 56 so that the second end 55 of the lever 53 is moved out of engagement with the handle member 46. The handle member 46 is then freely slidable within the slot 37 of the base 30, and the slide transfer system 10 can be operated to push the wafers 11 out of the carrier cassette 12 and into the process cassette 13.

It will be appreciated that the present invention is not limited to the exact constructions that have been described above and illustrated in the accompanying drawings, and that various modifications and changes can be made without departing from the scope and spirit of the invention. For example, the various shapes and designs of the carrier cassette and the process cassette disclosed herein are illustrative, and other shapes and designs may also be used with the slide transfer system of the invention. Other embodiments and variations not described herein are to be considered within the scope of this invention as defined by the following claims.

What is claimed is:

1. A slide transfer system for transferring semiconductor wafers from a first cassette to a second cassette, comprising:
a base having a first surface for supporting a first cassette and a second surface for supporting a second cassette adjacent to the first cassette;
a transfer mechanism having a wafer engaging member supported by a slidable support member, said support member being slidably mounted to said base for reciprocating movement of said wafer engaging member across said first surface; and
a locking mechanism having an actuator element and a locking element, said actuator element being positioned for engagement by a second cassette placed on said second surface, said locking element having a first position in which sliding movement of said transfer mechanism is prevented and a second position in which sliding movement of said transfer mechanism is permitted, and said actuator element being operable to move said locking element between said first and second positions, whereby said locking mechanism allows sliding movement of said transfer mechanism only when a second cassette is placed on said second surface for receiving wafers transferred from the first cassette.

2. The slide transfer system according to claim 1, wherein said actuator element is a pin member that protrudes upwardly from said second surface of said base when said locking element is in its first position.

3. The slide transfer system according to claim 2, wherein said pin member is movable downwardly when a second cassette is placed on said second surface, and said locking element is moved to its second position by downward movement of said pin member.

4. The slide transfer system according to claim 1, wherein said locking element comprises a lever having a first end engaged by said actuator element, a second end movable into and out of engagement with said transfer mechanism, and a fulcrum point between said first and second ends.

5. The slide transfer system according to claim 1, wherein said transfer mechanism further comprises a handle member extending across said base and movable within a slotted opening of said base, said handle member being connected to said support member for movement of said wafer engaging member across said first surface upon reciprocating movement of said handle member.

6. The slide transfer system according to claim 5, wherein said locking element engages and prevents movement of said handle member when said locking element is in its first position.

7. The slide transfer system according to claim 1, wherein said wafer engaging member comprises a means for pushing a plurality of wafers from a first cassette into a second cassette upon movement of said wafer engaging member across said first surface of said base.

8. A wafer handling system, comprising:
a first cassette for supporting a plurality of wafers in a stacked configuration;
a second cassette for receiving the wafers from said first cassette; and
a slide transfer system for transferring the wafers from said first cassette into said second cassette, said slide transfer system comprising:
a base having a first surface on which said first cassette is supported and a second surface on which said second cassette is supported, said second surface being adjacent to said first surface;
a transfer mechanism having a wafer engaging member supported by a slidable support member, said support member being slidably mounted to said base for reciprocating movement of said wafer engaging member across said first surface; and
a locking mechanism having an actuator element and a locking element, said locking element having a first position in which sliding movement of said transfer mechanism is prevented and a second position in which sliding movement of said transfer mechanism is permitted, and said actuator element being engaged by said second cassette to move said locking element into said second position to allow sliding movement of said transfer mechanism when said second cassette is placed on said second surface.

9. The wafer handling system according to claim 8, wherein said first cassette is a carrier cassette and said second cassette is a process cassette.

10. The wafer handling system according to claim 8, wherein said first and said cassettes have open sides facing each other when said cassettes are placed on said first and second surfaces of said base, respectively, and said first cassette has an open rear side through which said wafer engaging member is inserted to push the wafers from said first cassette into said second cassette.

11. The wafer handling system according to claim 8, wherein said actuator element is a pin member that protrudes upwardly from said second surface of said support platform when said locking element is in its first position.

12. The wafer handling system according to claim 11, wherein said pin member is movable downwardly when said second cassette is placed on said second surface, and said locking element is moved to its second position by downward movement of said pin member.

13. The wafer handling system according to claim 8, wherein said locking element comprises a lever having a first end engaged by said actuator element, a second end movable into and out of engagement with said transfer mechanism, and a fulcrum point between said first and second ends.

14. The wafer handling system according to claim 8, wherein said transfer mechanism further comprises a handle member extending across said base and movable within a slotted opening of said base, said handle member being connected to said support member for movement of said wafer engaging member across said first surface upon reciprocating movement of said handle member.

15. The wafer handling system according to claim 14, wherein said locking element engages and prevents movement of said handle member when said locking element is in its first position.

16. The wafer handling system according to claim 8, wherein said wafer engaging member comprises a means for pushing a plurality of wafers from said first cassette into said second cassette upon movement of said wafer engaging member across said first surface of said base.

17. A slide transfer system for transferring articles from a first support member to a second support member, comprising:
a base having a first surface for supporting a first support member and a second surface for supporting a second support member;
a transfer mechanism having an engaging portion arranged for reciprocating movement across said first surface and a supporting portion slidably mounted to said base; and
a locking mechanism having a first position in which sliding movement of said transfer mechanism is prevented and a second position in which sliding movement of said transfer mechanism is permitted, said locking mechanism being movable into said second position only when a second support member is placed on said second surface.

18. The slide transfer system according to claim 17, wherein said first and second support members are cassettes for carrying semiconductor wafers, and said engaging portion of said transfer mechanism comprises a means for pushing a plurality of wafers from one cassette to another.

19. The slide transfer system according to claim 17, wherein said locking mechanism comprises an actuator pin protruding from said second surface for engagement by a second support member placed on said second surface, and a locking lever having a first end engaged by said actuator pin, a second end movable into and out of engagement with said transfer mechanism, and a fulcrum point between said first and second ends, said actuator pin being movable downwardly upon engagement with a second support member to move the second end of said locking lever out of engagement with said transfer mechanism.

20. The slide transfer system according to claim 17, wherein said transfer mechanism further comprises a handle member extending across said base and movable within a slotted opening of said base, said handle member being connected to said supporting portion for movement of said engaging portion across said first surface upon reciprocating movement of said handle member, said locking mechanism engaging and preventing movement of said handle member when said locking mechanism is in its first position.
